(19) United States
(12) Patent Application Publication
(10) Pub. No.: US 2006/0027459 A1
(43) Pub. Date: Feb. 9, 2006

(54) Mesoporous silicon infrared filters and methods of making same

(75) Inventors: Marc Christophersen, Westerville, OH (US); Vladimir Kochergin, Westerville, OH (US); Philip R. Swinehart, Westerville, OH (US)

Correspondence Address: NIXON & VANDERHYE, PC, 901 NORTH GLEBE ROAD, 11TH FLOOR, ARLINGTON, VA, 22203, US

(73) Assignee: Lake Shore Cryotronics, Inc., Westerville, OH (US)

(21) Appl. No.: 11/138,672

(22) Filed: May 27, 2005

Related U.S. Application Data
(60) Provisional application No. 60/575,099, filed on May 28, 2004.

(51) Int. Cl. B23H 3/00

(52) U.S. Cl. 205/79; 205/674

(57) ABSTRACT

Mesoporous silicon optical filters can be used to filter light in the near infrared, mid infrared and/or far infrared spectral ranges. The special advantages of mesoporous filters in cold temperature applications include improved mechanical stability, absence of delamination problems, manufacturability, and transparency of the mesoporous silicon material throughout a wide spectral range. Techniques are disclosed for enhancing the transparency range and environmental and mechanical stabilities of the mesoporous silicon filters.

### CROSS-REFERENCES TO RELATED APPLICATIONS

This application claims the benefit of provisional application 60/575,099 filed May 28, 2004, incorporated herein by reference.

### STATEMENT REGARDING FEDERALLY SPONSORED RESEARCH OR DEVELOPMENT

This invention was made with Government support under Contract NNC04CA21C awarded by NASA. The Government has certain rights in the invention.

### FIELD

The technology herein relates to optical filters made of porous silicon, and more specifically to optical filters made of mesoporous silicon. Still more particularly, the technology herein relates to the applications of mesoporous silicon optical filters, including filters that can be readily thermally cycled to and used at extreme temperatures.

The filters of the exemplary non-limiting illustrative implementation can be used to filter the light in the near infrared, mid infrared and/or far infrared spectral ranges. The special advantages of mesoporous filters of the exemplary non-limiting illustrative implementation in extreme temperature applications include improved mechanical stability, absence of delamination problems, manufacturability, and transparency of the mesoporous silicon material throughout a wide spectral range. In addition, an exemplary, non-limiting illustrative implementation is disclosed that is related to a means of enhancing the optical transparency and environmental and mechanical stability of the mesoporous silicon filters by means of a sintering process and/or a wafer bonding process.

### BACKGROUND AND SUMMARY

Generally, optical filters and coatings are passive components whose basic function is to define or improve the performance of optical systems. There are many types of optical filters. They are used for a broad range of different applications. Applications of optical filters and coatings can be diverse as anti-glare computer screens, colored glass, sighting devices, and electrical spark imagers—to name just a few.

Some optical filters are specialized for different wavelength ranges of light because of limitations in available materials that are optically transparent in the range of interest. For example, many applications and instruments require optical filters that can be used to tune the optical behavior of light in the near infrared, mid infrared or far infrared wavelength range (i.e., at frequencies of radiant energy that are generally below the frequencies of visible light). Some example applications for such filters include far- and mid-IR focal-plane arrays for military applications, chemical sensing, astronomy, wavelength division multiplexing in optical communications, and space observations to name a few.

Some of these applications (especially those used in mid and far IR imaging) require filters to be cooled to cold temperatures (mid IR filters usually to 40-50K and far IR filters down to liquid He temperatures). Military and astronomy applications are typical examples. Extreme cold can cause problems with mechanical integrity of the filters, such as severe delamination. Common interference filters used in such applications often consist of many layers of dissimilar materials (up to several micrometers each for far IR filters), which are commonly deposited at or above room temperature. Thermal stresses during the cooling of the filters can cause these layers to delaminate. This can severely limit the maximal size of the filter, physical longevity and, through that the performance and cost-of-exploitation of the optical system incorporating said filters.

From another point of view, mesoporous silicon filters were proposed for the room temperature applications a decade ago. See, for example, Vincent G., “Optical-properties of porous silicon superlattices”, Appl. Phys. Lett., 64 (18): 2367-2369, May 1994; foreign Application priority Jun. 14, 1993 [DE], 43 19 413.3; and U.S. Pat. No. 6,130,748 (issued Oct. 10, 2000 to M. Krueger et al., claiming priority to DE Patent 196 08 428 issued Mar. 5, 1996).

Generally, mesoporous silicon is porous silicon material with pores in the range of 5 nm to 50 nm embedded in the silicon host. It can be obtained by electrochemical etching the highly doped silicon wafers (n-type or p-type), having resistivity typically in the range of 0.001-0.05 Ωcm, in HF-containing electrolytes. The multilayer structure with different porosity in different layers can easily be obtained by temporal variations of the electrochemical etching parameters during the etching process. The most prevalent parameter used to control the porosity is the anodization current density. Different porosities in different layers cause different refractive indices, so interference filters can be realized using this technique.

Although the fabrication method of such filters is fairly simple and cost-effective, prior mesoporous filters when operating at room temperatures can exhibit some disadvantageous properties that have prohibited the wide commercial use of such filters to date. One such property is, for example, the high chemical reactivity of the unpackaged mesoporous silicon. The extremely high surface area of mesoporous silicon can cause very efficient absorption of different species on the pore walls, causing spectral shifts of the transmission and/or reflection feature positions of the filters, degradation of the transmission and/or rejection efficiency of the filters, etc. The main disadvantage, however, is that mesoporous filters, when operating at room temperature, suffer from high absorption in the un-etched portion of the silicon wafer. This effect prohibits the operation of the mesoporous silicon filters in the transmission mode (which is desired for a majority of applications) unless the mesoporous layer is made in a membrane mode. This can be done by the intentional lifting-off of the mesoporous silicon layer from the silicon substrate at the end of the electrochemical etching process, or by removing the non-porous part of the silicon wafer by some kind of etching (e.g., RIE) after the formation of the mesoporous silicon multilayer. However, the mesoporous silicon membrane is usually mechanically weak and not suitable for most applications. When considering the effects of absorption in the transmission mode, it is important to consider separately the mesoporous silicon itself and the bulk silicon substrate. At room temperature, a bulk silicon substrate with a doping density around 0.01 Ωcm has a very narrow transmission band (roughly from the 1100 nm—band edge of silicon to the 1300 nm—free carrier absorption edge). Hence, when still on the silicon substrate, mesoporous silicon filters can be operational only in this narrow range in the transmission mode. The number of applications utilizing the reflection mode (as a wavelength selective or broad-range IR mirror) is generally smaller than those utilizing transmission mode or both modes, but is still substantial. However, even in the case of the reflection mode, the free-carrier absorption still can cause some problems. Free-carrier absorption, which is strongly red-shifted for as-prepared mesoporous silicon, can shift back substantially due to adsorption of any polar gas molecules on the pore walls. In order for mesoporous silicon-based optical filters to reach market acceptance, these problems should be solved.

Several methods of improving the environmental stability of mesoporous silicon have been suggested. For example, in [Mulloni V., Pavesi L., “Electrochemically oxidized porous silicon microcavities”, Mat. Sci. Eng. B-Solid. 69: 59-65 Sp. Iss. SI, January 2000], the electrochemical oxidation of mesoporous silicon multilayers has been proposed to suppress the aging effect and related spectral shift of the reflection band position. Although such a method has shown considerable improvement, it has some drawbacks as well. Silicon oxide is has several pronounced absorption bands in the IR. Thermal oxidation has also been suggested. However, this technique, while having all the drawbacks of the chemical oxidation, also creates substantial stress in the mesoporous silicon layer (thus reducing mechanical stability of the filters).

The sintering of mesoporous silicon is a well-known Canon technique (ELTRAN™) for the large scale fabrication of the SOI (Silicon-on-Insulator) wafers. See, for example, integrated circuit manufacturing applications in U.S. Pat. No. 6,593,211 “Semiconductor Substrate and method for producing the same” assigned to N. Sato, issued Jul. 15, 2003, or U.S. Pat. No. 6,413,874 “Method and apparatus for etching a semiconductor article and method of preparing a semiconductor article by using the same” assigned to N. Sato, issued Jul. 2, 2002). In the sintering process, the mesoporous silicon is heat treated, preferably in a hydrogen atmosphere, at high temperatures between 800° C. and 1150° C., which results in morphological changes of the pores (see [G. Muller and R. Brendel, Phys. Stat. Sol. A, 182, p. 313 (2000) and [G. Muller et al., Phys. Stat. Sol. A, 197 (1), pp. 83-87 (2003)]). One peculiarity of said morphological changes is the closure of the pores at the mesoporous silicon surface. In the ELTRAN™ process, this leads to the reduction of stacking faults in the resulting SOI wafer.

Bonding of semiconductor wafers is a well known technique widely used in MEMS (Micro Electro-Mechanical Systems), and other processes (see, for example, U. Gösele & Q.-Y. Tong, Annual Review of Materials Science 1998, Vol. 28: 215-241, and references therein). In such a process, two wafers are brought into close contact and bonded together either by applying current through the interface (anodic bonding) or by fusion bonding, i.e. heating to a high temperature (typically within the 800-1150° C. range). The fusion bonding method is attractive since very high quality bonding can be obtained and electrical conductivity through the bonded interface can be preserved (unlike the case of anodic bonding). However, this method has not been used in prior art with porous silicon optical components.

The exemplary illustrative non-limiting technology herein provides practical solutions for aforementioned problems. More particularly, the exemplary illustrative non-limiting technology herein provides practical methods of manufacturing of mesoporous silicon infrared filters with excellent quality mechanical and environmental stability and good transparency over a wide spectral range. The exemplary illustrative non-limiting technology herein also provides a method of manufacturing of mesoporous silicon infrared filters to be used at cold temperatures.

According to an illustrative exemplary non-limiting implementation, the environmental and mechanical stability of mesoporous silicon optical filters is improved by performing the sintering of a mesoporous silicon multilayer to suppress penetration of reactive species in liquid or gaseous form onto the pore walls. According to the second aspect of the present exemplary non-limiting implementation, the environmental and mechanical stability of the mesoporous silicon optical filters is further enhanced by bonding (direct, anodic or any other type of bonding known to those skilled in the art) said wafer containing the sintered mesoporous silicon multilayer to another wafer so the sintered mesoporous silicon layer is effectively encapsulated between two nonporous wafers. Said second wafer can be either relatively low-doped (with resistivity>10 Ωcm) silicon of any other kind of material that can be bonded to the silicon and that is sufficiently transparent within the designed transparency range of the final optical filter. One or both sides of the filter can be coated by antireflection layers, which can be one or more layers of different materials or a microstructured layer etched into the wafer surface, a motheye structure. The mesoporous silicon infrared filter of the present exemplary non-limiting implementation will exhibit improved mechanical/environmental stability. However, the substrate infrared absorption problem will not be solved, so the filter will be suitable for use in either the reflective mode (as a wide-band or wavelength-selective mirror) or only at very cold temperatures (around 4° K) in the mid IR range in a transmission mode.

According to a second illustrative exemplary non-limiting implementation, the transparency of the mesoporous silicon optical filters in the infrared spectral range can be improved, while the environmental and mechanical stability of filters can be enhanced by:
sintering the mesoporous silicon multilayer;
bonding said wafer containing said sintered mesoporous silicon multilayer to a second wafer such that the sintered mesoporous silicon layer is effectively hermetically encapsulated between two nonporous wafers. Said second wafer can be either silicon of any other kind of material that can be bonded to the silicon and that is sufficiently transparent within the designed transparency range of the final optical filter, and
removing at least partially the un-etched part of the more highly doped silicon wafer on which the mesoporous multilayer has been electrochemically etched.

According to the first aspect of the third illustrative exemplary non-limiting implementation, the transparency of the mesoporous silicon layers can be improved while keeping the mechanical stability of the filter at good levels by
Bonding of a relatively low-doped silicon wafer (with doping level sufficient for electrical conductance across the wafer thickness but low enough to be optically transparent within at least part of the far IR spectral range) to a relatively highly-doped silicon wafer with the doping density needed to form a mesoporous silicon optical multilayer, and a thickness substantially equal to the desired thickness of the mesoporous silicon multilayer,
Depositing an electrical contact layer on the lower-doped side of the silicon bonded wafer,
Electrochemical etching of the higher-doped side of the bonded silicon wafer pair under conditions required to form a mesoporous silicon multilayer composed of porous layers of different porosities, with a structure appropriate to perform as an infrared filter, and
Stripping the electrical contact layer from the lower-doped side of the bonded wafer.

The silicon wafer bonding in this illustrative exemplary non-limiting implementation can be, as a nonlimiting example, fusion bonding (also known as the direct bonding technique). The annealing step (a necessary step in fusion bonding in order to form a strong bond between the wafers) should be performed at temperatures sufficiently low to prevent the diffusion of the dopants from the highly doped portion of the bonded wafer pair into the lower-doped portion of the bonded wafer pair, since said diffusion of the dopants can cause the loss of the transparency of the mesoporous silicon filter structure, at least at above 100K in temperature. Preferably, said annealing should be performed at temperatures between 350° C. and 1000° C. at as short a time as possible to achieve the required bond strength without unwanted diffusion of dopants. Also, in order to maintain the electrical conductivity across the bonding interface, the native oxide layer must be stripped (for example, in HF solution) prior to bonding. The quality of the bonding should be such that the amount of voids or “bubbles” (unbonded areas) are minimal. Electrical contact layer deposition can be accomplished by sputtering, thermal or e-beam evaporation or any other deposition technique known to those skilled in the art. The electrochemical etching in this illustrative exemplary non-limiting implementation should be stopped when the porous silicon layer is approaching the bonding interface. This can be easily detected by monitoring the current/voltage characteristics of the etching system during the electrochemical etching process. Further, an antireflection coating can be provided on the lower-doped side of the bonded wafer prior or after the electrochemical etching step in order to suppress the reflection losses on the flat silicon surface. This can be done the same way as was disclosed in relation to the previous modes of the present illustrative exemplary non-limiting implementation. The mesoporous silicon filters fabricated according to this implementation of the present illustrative exemplary non-limiting implementation will exhibit good transparency over a wide spectral range, will exhibit good mechanical stability and can be used over an extremely wide temperature range since thermal expansion/contraction stresses will not be present. This is because the degree of porosity does not affect the thermal expansion coefficient of the silicon. However, environmentally the filter structure will not be any more stable than prior art mesoporous silicon filters.

According to the second aspect of the third illustrative exemplary non-limiting implementation, the transparency of the mesoporous silicon layers can be improved and the environmental stability of the filter can be strongly enhanced while keeping the mechanical stability of the filter at good levels by
Bonding of a relatively low-doped silicon wafer, possessing a doping level sufficient for electrical conductance across the wafer thickness, but low enough to be optically transparent within at least part of far IR spectral range, to a relatively highly-doped silicon wafer with doping density sufficient to form a mesoporous silicon optical multilayer and thickness approximately equal to the desired thickness of the mesoporous silicon multilayer,
Depositing an electrical contact layer on the lower-doped side of the silicon bonded wafer pair
Electrochemical etching of the higher-doped side of the bonded silicon wafer under conditions required to form a mesoporous silicon multilayer composed of porous layers of different porosities, with a structure appropriate to perform as an infrared filter,
Stripping the electrical contact layer from the lower-doped side of the bonded wafer, and
Sealing the surface of the mesoporous silicon multilayer to enhanced the environmental stability of the filter structure.

Wafer bonding, electrical contact deposition, electrochemical etching and electrical contact layer stripping can be accomplished in the same manner as was disclosed in relation to previous non-limiting implementations. The sealing of the filter surface can be performed by depositing a layer of a suitably transparent material onto the surface of the mesoporous silicon layer. As a nonlimiting example, said transparent material can be silicon, silicon oxide, silicon nitride or any other material sufficiently transparent in the desired wavelength range. The thickness of the deposited layer should be sufficient to close off the pores at the surface of the mesoporous silicon layer. Since the pore size in the porous silicon layer is typically in the range of 10-to-50 nm, the thickness of the sealing layer can be as thin as 50-to 100 nm. Since the sealing layer can be so thin, materials can be utilized that exhibit some absorption in the specified wavelength band or over some part of it. The deposition of the sealing layer can be accomplished by magnetron sputtering, various modifications of chemical vapor deposition (CVD), thermal- or e-beam evaporation or by any other deposition technique known by those skilled in the art. It should be noted that, due to unique structure of the mesoporous silicon layer, said thin sealing layer will be less subject to delamination.

Alternatively, said sealing of the surface of the mesoporous silicon layer can be accomplished by sintering of the mesoporous silicon layer surface. This can be done, for example, by first forming a very thin layer of silicon oxide on the pore walls. This can be as little as several nm, which can be done by annealing the mesoporous silicon layer at relatively low temperatures, preferably in the range of 400° C. and 600° C. in an oxygen-containing atmosphere; by a second step of stripping said thin oxide layer from the pore walls in the close vicinity of the mesoporous silicon layer surface, which could be accomplished by a very short rinse of the mesoporous silicon layer in dilute HF solution, by exposure to HF vapors, by selective RIE or by any other method known to those skilled in the art; and by a third step of performing a sintering process according to the technique disclosed in relation to the previous illustrative exemplary non-limiting implementations.

Alternatively, said sealing of the mesoporous layer surface can be performed by partial thermal oxidation of the mesoporous silicon layer.

It should be noted that that the low-doped side of the bonded wafer can be provided with an antireflection structure prior to or after the electrochemical etching process, as was disclosed in relation to the previous aspect of an illustrative exemplary non-limiting implementation. It should be also noted that the mechanical and environmental stability of the mesoporous silicon filter can be further enhanced by bonding of another wafer of material that is transparent at the desired wavelengths to the sealed mesoporous silicon surface of the filter, as was disclosed in accordance to the previous non-limiting implementation.

Such exemplary, non-limiting, illustrative implementations provide workable mesoporous silicon optical filters for applications that require the operation of such filters at low temperatures (below 100° K). Such filters exhibit much better mechanical stability than, for example, common multilayer interference filters made of layers of dissimilar materials. This is due to the matched thermal expansion between the layers of different porosity in the mesoporous silicon multilayer structure, and thus due to the absence of mechanical stress between said layers.

### BRIEF DESCRIPTION OF THE DRAWINGS

These and other features and advantages provided by exemplary non-limiting illustrative implementations will be better and more completely understood by referring to the following detailed description in connection with the drawings, of which:

FIG. 1a is an illustrative SEM cross-sectional image of a mesoporous silicon optical filter structure;

FIG. 1b is an illustrative SEM cross-sectional image of mesoporous silicon optical filter structure at high magnification; low and high porosity layers are visible and individual pores are resolved on the insert;

FIG. 2a is an illustrative SEM cross-sectional images illustrating the changes in morphology of the mesoporous silicon multilayer resulting from the sintering process;

FIG. 2b is an illustrative, exemplary, non-limiting schematic drawing of the bonding of a solid wafer to the surface of the mesoporous layer;

FIG. 2c is an illustrative, exemplary, non-limiting schematic drawing of the bonding of high and low doping density wafers prior to the etching of the mesoporous layer;

FIG. 3a is a flowchart illustrating exemplary, non-limiting steps for fabricating mesoporous silicon filters according to the first illustrative exemplary non-limiting implementation;

FIG. 3b is a schematic drawing illustrating exemplary, non-limiting steps for fabricating mesoporous silicon filters according to the first illustrative exemplary non-limiting implementation;

FIG. 4a is a flowchart illustrating exemplary, non-limiting steps for fabricating mesoporous silicon filters according to the second aspect of the first illustrative exemplary non-limiting implementation;

FIG. 4b is a schematic drawing illustrating exemplary, non-limiting steps for fabricating mesoporous silicon filters according to the second aspect of the first illustrative exemplary non-limiting implementation;

FIG. 5a is a flowchart illustrating exemplary, non-limiting steps for fabricating mesoporous silicon filters according to the second illustrative exemplary non-limiting implementation;

FIG. 5b is a schematic drawing illustrating exemplary non-limiting illustrative steps for fabricating mesoporous silicon filters according to the second illustrative exemplary non-limiting implementation;

FIG. 6a is a flowchart illustrating exemplary non-limiting illustrative steps for fabricating mesoporous silicon filters according to the third illustrative exemplary non-limiting implementation;

FIG. 6b is a schematic drawing illustrating exemplary non-limiting illustrative steps for fabricating mesoporous silicon filters according to the third illustrative exemplary non-limiting implementation;

FIG. 7a is a flowchart illustrating exemplary, non-limiting steps for fabricating mesoporous silicon filters according to the second aspect of the third illustrative exemplary non-limiting implementation;

FIG. 7b is a schematic drawing illustrating exemplary, non-limiting steps for fabricating mesoporous silicon filters according to the second aspect of the third illustrative exemplary non-limiting implementation; and

FIG. 8 is an illustrative SEM cross-sectional image of a part of a mesoporous silicon optical filter structure fabricated according to the third illustrative exemplary non-limiting implementation.

### DETAILED DESCRIPTION

An exemplary, non-limiting illustrative mesoporous silicon filter structure can be fabricated on the surface of a silicon wafer by starting with silicon wafers of either n-type or p-type doping with a resistivity in the range of 0.5 mΩcm to 0.5 Ωcm, more preferably 1 mΩcm to 100 mΩcm, which has a front side (first surface of the wafer) and a back side (second surface of the wafer). In an exemplary illustrative implementation, the front side of the wafer is polished. The back side of the wafer can also be polished if the filter is to be used in a transmission mode (in this case the silicon wafer is termed ‘double side polished’), or if the filter is to be used in a reflection mode (as a wavelength selective or wide wavelength mirror), the back side of the wafer can be left unpolished. An electrical contact layer is then deposited on the backside of the wafer. Said electrical contact layer can be a single metal (such as Au, Cu, Al, Ta), a metal multilayer (Ta/Co, etc.), a conductive oxide (for example, indium tin oxide), or, alternatively, formed in the silicon wafer itself by ion implantation with optional annealing following the implantation.

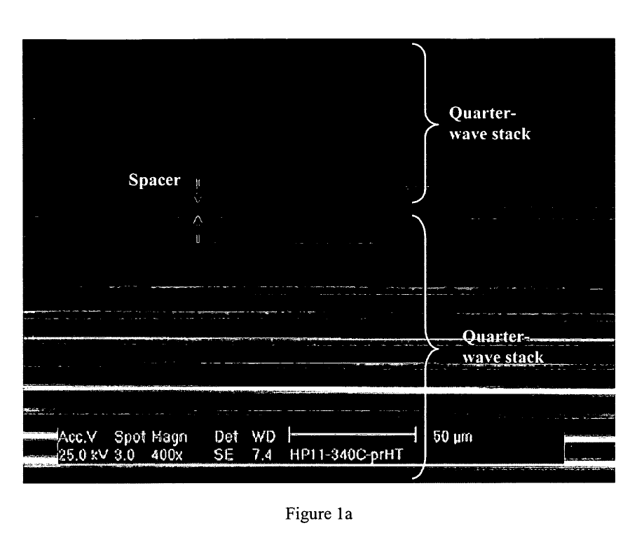

The wafer can then be placed in an electrochemical etching cell, (e.g., the front side of the wafer can be set in contact with electrolyte), while the backside of the wafer is contacted to a power supply. The counter electrode is, in one illustrative arrangement, placed into the electrolyte at some distance from the silicon wafer. Current is applied between the electrode in electrolyte (which serves as the cathode) and the silicon wafer (which serves as the anode). The electrolyte may for example contain hydrofluoric acid (HF) and water. The HF concentration may be within 5 to 40%. In addition, the electrolyte can contain ethanol (or other alcohol), and some organic additive to increase the wetting and to suppress the random defects that could be caused by hydrogen bubble formation. Electrochemical etching of the front surface of the silicon wafer will then occur. During the electrochemical etching, in one exemplary illustrative implementation, the electrolyte is sufficiently and uniformly stirred and the electrical potential across the silicon wafer opening to the electrolyte is substantially uniform. The temperature of the electrolyte and the wafer are also well controlled in this exemplary illustrative arrangement. Said electrochemical etching of the front surface of the silicon wafer forms a porous layer on said front side of the wafer. According to the one illustrative example, the applied current density during the electrochemical etching is temporally modulated such that a predetermined porosity profile is created in said silicon wafer. The layers of the low and high porosity exhibit high and low refractive index, respectively, so a multilayer filter structure can be formed this way. The control of temporal variations of the applied current density during the electrochemical process gives the opportunity to control both the thickness and the refractive index (within limits) of each layer in a simple fashion. An illustrative SEM cross-sectional image of the mesoporous filter structure is given in FIG. 1a showing alternating layers of high and low porosity arranged in two quarter-wave stacks with a spacer layer (also known as a “phase-shift” or “cavity”) in between. FIG. 1b shows the illustrative cross-sectional SEM image of the mesoporous silicon multilayer at higher magnification.

According to a further illustrative, non-limiting example, electrochemical etching of mesoporous silicon optical filter structure can be done by means of temporal variation of the applied potential between the cathode (electrode placed in electrolyte) and an anode (silicon wafer). According to a still further illustrative example, the multilayer mesoporous structure can be formed by a preliminary deposition of multilayer high-doped/lower-doped silicon (by, for example, Chemical Vapor Deposition) onto the front side of the wafer, with subsequent electrochemical etching of said wafer under temporally constant etching conditions.

After electrochemical etching is complete, the wafer can be removed from the electrolyte and, in one exemplary non-limiting arrangement, carefully rinsed and dried. The backside electrical contact layer can be removed through either chemical etching or reactive ion etching. In principle, such a filter structure will exhibit spectral filtering. However, it will also exhibit all the drawbacks (environmental and mechanical instability, insufficient transparency, etc.), discussed in more detail above.

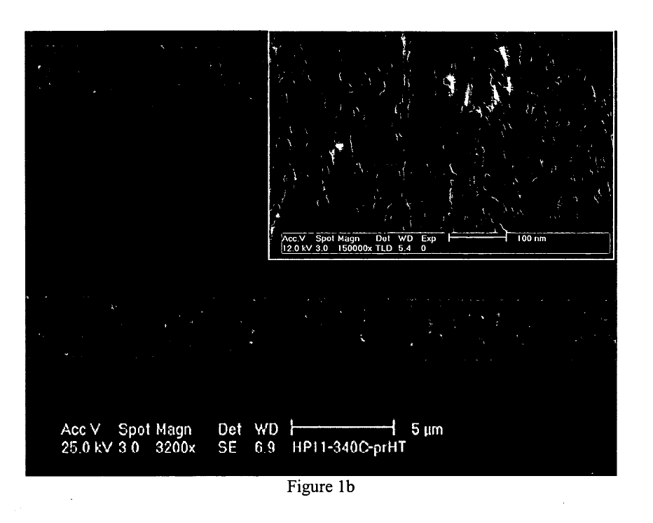

The environmental and mechanical stability of the mesoporous silicon optical filter produced as described above can be enhanced by a sintering process performed after the electrochemical etching of the structure. Sintering of mesoporous silicon filters can be performed by placing the wafers containing mesoporous filter structures into an oven containing a hydrogen atmosphere, or an atmosphere composed of hydrogen and some inert gas (e.g. Ar) mixture, at temperatures between 500° C. and 1150° C. for a sufficient amount of time. For most such processes, a predetermined time within the range of 50 s and 600 s is sufficient, depending on oven temperature and other parameters. It should be noted that the oxygen or water vapor content in the oven's atmosphere should, in one exemplary non-limiting arrangement, be minimized to suppress silicon oxidation, which is known to interfere with sintering. Gases flowing through the oven can be additionally filtered to prevent moisture or oxygen from entering the sintering chamber. The sintering apparatus can be load-locked to speed up processing time. In addition, the wafer containing the mesoporous silicon multilayer may be dipped into HF or dilute HF to strip the native oxide from the pore walls if the wafer was electrochemically etched a substantial time before the sintering process. The sintering of a mesoporous silicon multilayer structure will result in the closure of the pores at the mesoporous silicon surface and the overall modification of the porosity (and through that, the refractive indices) of the porous layers comprising the mesoporous silicon optical filter structure. This is illustrated in FIG. 2a. This in turn can result in spectral shift and possible reshaping of the mesoporous silicon filter pass and/or rejection band and, possibly, transmission levels within the pass band/bands and/or rejection level of the rejection band/bands. This effect can be compensated, for example, through calibration runs.

In order to prevent morphological changes throughout the whole depth of the mesoporous silicon multilayer occurring during the sintering process (as disclosed so far), but still allow the sealing of the top surface of the mesoporous silicon layer, the sintering process can be modified. In this case, a thin (several nm) layer of silicon oxide can be grown on the pore walls (this can be done, for example, by thermal oxidation at relatively low temperatures, between 400 and 600° C.) and then it can be stripped near the first surface of the wafer. This localized stripping can be done by wet chemical etching in a dilute HF solution (by performing short, less than 300 s, rinse of the wafer), by short exposure of the mesoporous silicon layer to HF vapors or by a selective reactive ion etching step. The sintering of a mesoporous silicon layer prepared according to such a process will result in sintering only the portion of the mesoporous silicon structure where the oxide was stripped from the pore walls, since the layer of silicon dioxide will inhibit the mobility of the silicon atoms and thus will inhibit unwanted sintering.

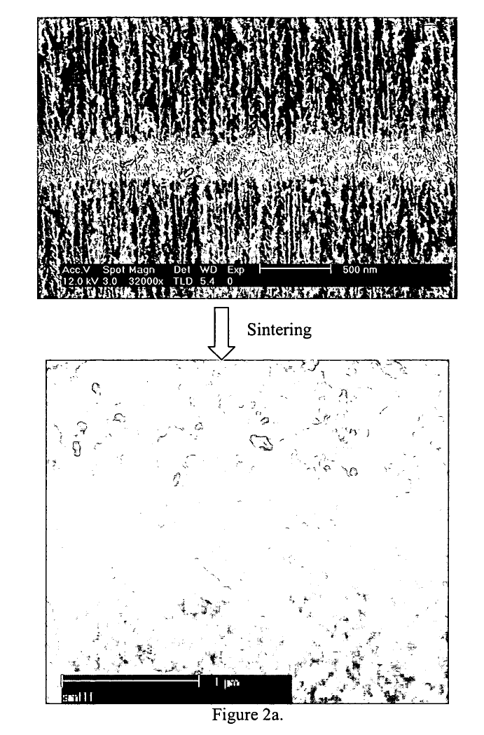

Filters fabricated as described above will generally exhibit substantially improved mechanical and environmental stability, which can be useful for applications requiring spectral filtering in the far infrared range. To improve the optical performance of the optical filter (e.g., improved transmission level within the pass band for the transmission-type filter and/or improved reflection within the reflection band for the reflection-type filter) the front side of the wafer (i.e., mesoporous silicon layer surface) and/or back side of the wafer (for the transmission-type filters) can be coated by an antireflective (AR) structure or coating which can consist of one or more layers of transparent materials, the design and deposition of which is well known to those skilled in the art. Alternatively, the antireflective structure can be made in the form of a structured silicon layer, wherein said structuring is performed by chemical etching, reactive ion etching or ion milling and said structured reduces the reflectivity of the wafer surface. Such a structure is physically related to the Motheye structure, which is well known to those skilled in the art. An example flow chart of a non-limiting illustrative optical filter fabrication process is schematically shown in FIG. 3a, and FIG. 3b is a schematic drawing illustrating exemplary fabrication steps.

The environmental and mechanical stability of exemplary mesoporous silicon optical filters can be enhanced by sintering after the electrochemical etching of the structure and followed by the bonding of another wafer to the mesoporous silicon surface. Said sintering of mesoporous silicon filters can be performed as was disclosed in the previous mode of the optical filter fabrication of the present illustrative exemplary non-limiting implementation.

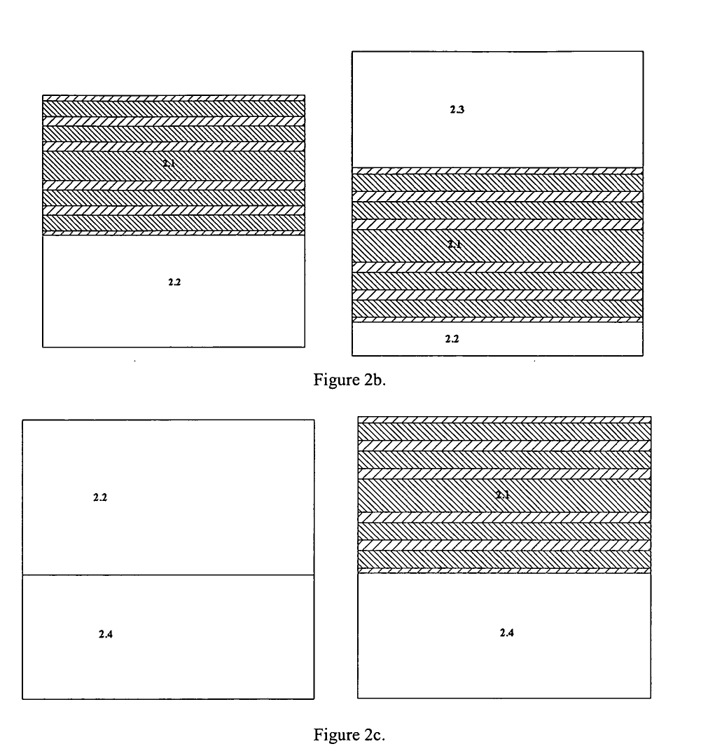

To reinforce the mesoporous structure, another wafer can be bonded to the front side of the wafer containing the etched mesoporous silicon structure. Said bonded wafer can be, for example, a silicon wafer with a different doping type and/or doping density, in this non-limiting example causing the free carrier absorption edge of said bonded wafer to be substantially red-shifted with respect to the wafer containing or bearing the mesoporous silicon layer. Alternatively, said bonded wafer can be, for example, sapphire, glass or any other material transparent within the operational spectral range of the filter which can be bonded to the silicon, known to those skilled in the art. Said bonded wafer can not only reinforce the mechanical and environmental stability of the mesoporous silicon optical filter structure, but also serve to block some spectral range if the material of said bonded wafer has its absorption range at suitable wavelengths. The bonding can be done by, for example, direct (or fusion) bonding. To perform this type of bonding, the surfaces of both wafers to be bonded should be chemically treated to induce the needed properties (either hydrophilic or hydrophobic). Then, the wafers are brought into mechanical contact and some pressure is applied across the interface, so the Van-Der-Vaals forces start holding the wafers together. The wafers (while being in the contact and optionally under the pressure) may then be heated to high temperature and held at such a temperature for some time to increase the strength of the bonding. Bonding temperatures can be up to 1300° C. if the second wafer is a silicon wafer or lower temperatures if the second wafer is, for example, a quartz wafer. Alternatively, said bonding can be done by the anodic bonding technique. In such a technique, the surfaces of the wafers to be bonded are brought into contact and a high voltage at low current is applied across the interface, causing bonding between surfaces. It should be noted that sintering mesoporous silicon will improve the quality of the bonding. Such a filter structure will exhibit very good mechanical and environmental stability. In addition, bonding two silicon wafers will generally exhibit excellent temperature stability due to the matched temperature expansion coefficients of the wafers. To improve the optical performance of the optical filter (i.e., improve the transmission level within the pass band for a transmission-type filter and improve the reflection within the reflection band for a reflection-type filter), the front side of the wafer (i.e., the surface of the wafer that was bonded) and/or back side of the wafer (for the transmission-type filters) can be coated by an antireflective structure or coating, as was disclosed in relation to the previous aspect of the present illustrative exemplary non-limiting implementation. A flow chart of an exemplary, illustrative non-limiting optical filter fabrication process is schematically shown in FIG. 4a, while a schematic drawing illustrating the exemplary steps of fabrication of said filter is shown in FIG. 4b.

The environmental and mechanical stability of the mesoporous silicon optical filter can be enhanced, while the transmission of said filter can be also enhanced in the infrared spectral range by performing the following exemplary steps after the electrochemical etching of the mesoporous multilayer structure:
sintering;
bonding another wafer to the sintered mesoporous silicon surface, and
removing at least part of the nonporous portion, on the side opposite the etched side, of the wafer that was electrochemically etched.

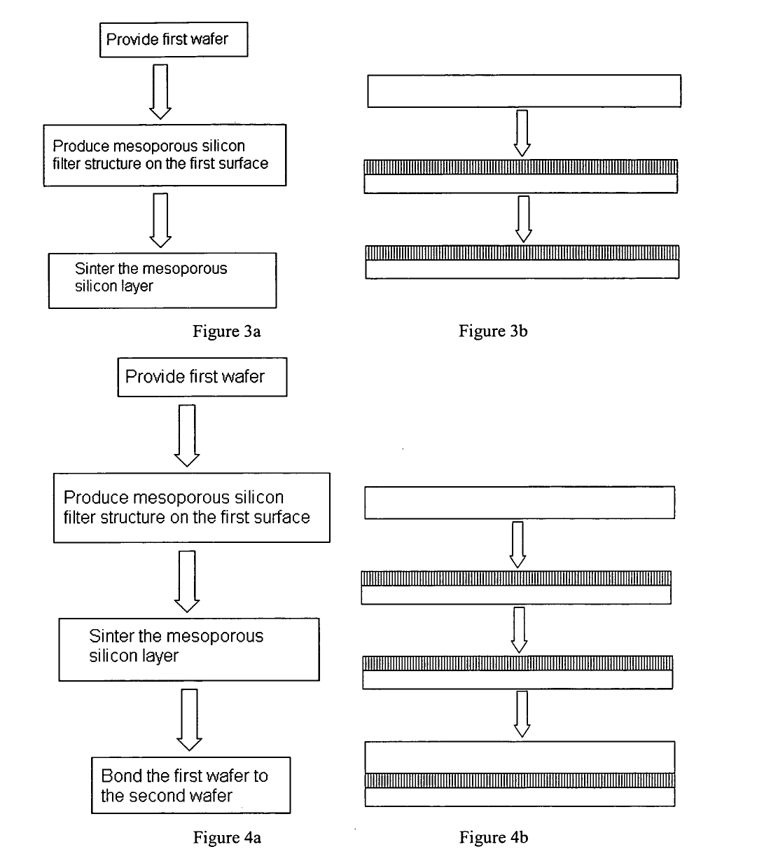

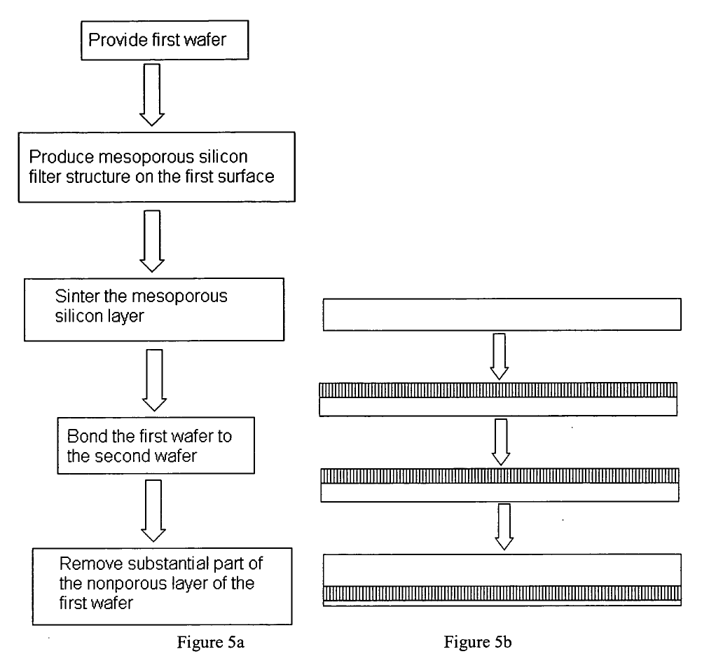

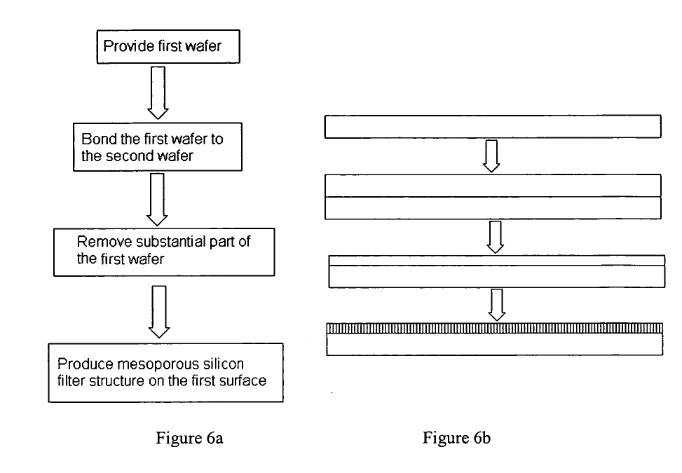

The sintering and bonding steps can be performed in a similar way as was disclosed in relation to the previous aspects of the present illustrative exemplary non-limiting implementation. As was discussed previously, the infrared transmission band of such a filter may be strongly limited at room temperature due to free carrier absorption, which is strong and starts in the mid IR for the typical doping densities that are suitable for etching the mesoporous silicon layer. Said free-carrier absorption can be strongly suppressed if a substantial part of the nonporous portion of the wafer that was electrochemically etched is removed by, for example, chemical etching, reactive ion etching, polishing, grinding or any other method of silicon removal known to those skilled in the art. Said removal can be done without strong degradation of the mechanical stability of the mesoporous silicon optical filter structure (e.g., especially if the mesoporous silicon layer 2.1 is reinforced by another wafer 2.3 bonded to it, as it is illustrated in FIG. 2b). The nonporous part of the silicon 2.2 wafer does not have to be removed completely. Instead, several micrometers of nonporous wafer can be left to protect and reinforce the mesoporous silicon filter structure. To improve the optical performance of the optical filter (improve the transmission level within the pass band for the transmission-type filter and improve the reflection within the reflection band for the reflection-type filter), the front side of the wafer (i.e., the surface of the wafer that was bonded) and/or back side of the wafer (for the transmission-type filters) can be provided with an antireflective structure as was disclosed in relation to the previous aspects of the optical filter fabrication. A flow chart of an exemplary, non-limiting illustrative optical filter fabrication process is schematically shown in FIG. 5a and a schematic drawing illustrating the steps of fabrication of said filter is shown in FIG. 5b.

According to the another exemplary non-limiting implementation, the transparency of the mesoporous silicon layers can be improved while keeping the mechanical stability of the filter at good levels by
Bonding of the relatively low-doped silicon wafer (with doping level sufficient for electrical conductance across the wafer thickness but low enough to be optically transparent within at least part of far IR spectral range, e.g. 1 to 200 Ωcm, and more preferably in the range of 20 to 100 Ωcm) to the relatively highly-doped silicon wafer with doping density needed to form a mesoporous silicon optical multilayer (with resistivity in the range of 0.0005 to 0.5 Ωcm, and more preferably in the range of 0.001 to 0.1 Ωcm) and thickness approximately equal to the desired thickness of the mesoporous silicon multilayer,
Depositing an electrical contact layer on the lower-doped side of the silicon bonded wafer,
Electrochemically etching the higher-doped side of the bonded silicon wafer under conditions needed to form a mesoporous silicon porosity multilayer with a structure appropriate to perform as an infrared filter, and
Stripping the electrical contact layer from the lower-doped side of the bonded wafer.

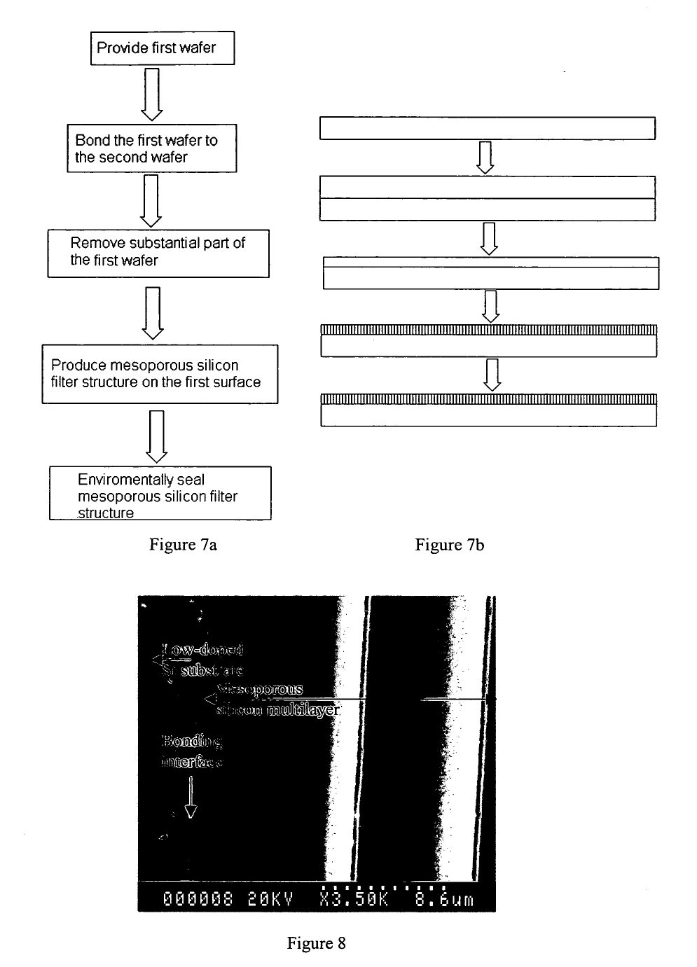

The silicon wafer bonding in this illustrative exemplary non-limiting implementation can be, as a nonlimiting example, fusion bonding (also known as the direct bonding technique). The annealing step, which is a necessary step in fusion bonding in order to form a strong bond between the wafers, should be performed at temperatures sufficiently low to prevent the diffusion of the dopants from the highly doped portion of the bonding wafer into the lower-doped portion of the bonded wafers, since said diffusion of the dopants can cause the loss of the transparency of the mesoporous silicon filter structure, at least at temperatures above 100K. Preferably, said annealing should be performed at temperatures between 350° C. and 1300° C., and more preferably in the range of 350° C. to 1000° C. Also, in order to maintain the electrical conductivity across the bonding interface, the native oxide layer must be stripped (for example in HF solution) prior to bonding. The quality of the bonding should be of adequate quality such that the amount of voids or “bubbles” (unbonded areas) is minimal. Electrical contact layer deposition can be done by sputtering, thermal or e-beam evaporation or any other deposition technique known to those skilled in the art. The electrochemical etching in this illustrative exemplary non-limiting implementation should be stopped when the porous silicon layer approaches the bonding interface. This can be easily detected by monitoring the current/voltage characteristics of the etching system during the electrochemical etching process. An antireflection coating can be provided on the lower-doped side of the bonded wafer prior or after the electrochemical etching step in order to suppress the reflection losses on the flat silicon surface. This can be done the same way as was disclosed in relation to the previous non-limiting implementations. The mesoporous silicon filters fabricated according to this illustrative exemplary non-limiting implementation will exhibit good transparency over a wide spectral range, will exhibit good mechanical stability and can be used over a wide temperature range since thermal expansion/contraction problems will not be present due to the uniform expansion coefficients in the structure (the filter will be “all-silicon”). However, environmentally the filter structure will not be any more stable than prior art mesoporous silicon filters. The exemplary illustrative cross-sectional SEM image of the mesoporous silicon filter layer etched all the way to the bonding interface is given in FIG. 8.

According to the second aspect of the third illustrative exemplary non-limiting implementation, the transparency of the mesoporous silicon layers can be improved and the environmental stability of the filter can be strongly enhanced while retaining the mechanical stability of the filter by:
Bonding of the relatively low-doped silicon wafer to the relatively highly-doped silicon wafer. The low-doped wafer should have a doping level sufficient for electrical conductance across the wafer thickness but low enough to be optically transparent within at least part of far IR spectral range, for example, with resistivity in the range of 1 to 200 Ωcm, and more preferably in the range of 20 to 100 Ωcm. The highly doped wafer should have the doping density needed to form a mesoporous silicon optical multilayer (with resistivity in the range of 0.0005 to 0.5 Ωcm, and more preferably in the range of 0.001 to 0.1 Ωcm) and thickness approximately equal to the desired thickness of the desired mesoporous silicon multi layer,
Depositing an electrical contact layer on the lower-doped side of the silicon bonded wafer
Electrochemically etching the higher-doped side of the bonded silicon wafer under conditions needed to form a mesoporous silicon porosity multilayer with a structure appropriate to perform as an infrared filter,
Stripping the electrical contact layer from the lower-doped side of the bonded wafer, and
Sealing the surface of the mesoporous silicon multilayer to enhanced the environmental stability of the filter structure.

Wafer bonding, electrical contact deposition, electrochemical etching and electrical contact layer stripping can be done the same way as was disclosed in relation to previous exemplary non-limiting implementation. The sealing of the filter surface can be performed by depositing a layer of a material that is transparent within the desired transparency range of the filter structure onto the surface of the mesoporous silicon layer. As a nonlimiting example, said transparent material can be silicon, silicon oxide, silicon nitride or any other material transparent sufficiently transparent within the desired wavelength range. The thickness of the deposited layer should be sufficient to “close” the pores on the surface of the mesoporous silicon layer. Since the pore size in the porous silicon layer is typically in the range of 10-to-50 nm, the thickness of the sealing layer can be as thin as 50-to 100 nm. Since the sealing layer can be so thin, it can exhibit some absorption at the specified wavelength band or over some part of it without damaging the overall transmission efficiency of the filter. The deposition of the sealing layer can be done by magnetron sputtering, various modifications of chemical vapor deposition (CVD), thermal- or e-beam evaporation or by any other deposition technique know by those skilled in the art. It should be noted that due to unique structure of the mesoporous silicon layer, said sealing layer will be less subject to delamination due to its thinness.

Alternatively, said sealing of the surface of the mesoporous silicon layer can be done by sintering the mesoporous silicon layer surface. This can be done, for example, by forming a very thin layer of silicon oxide on the pore walls Oust several nm, which can be done by annealing of the wafer containing the mesoporous silicon layer at relatively low temperatures, preferably in the range of 400° C. and 600° C.), stripping said thin oxide layer from the pore walls in the close vicinity of the mesoporous silicon layer surface and performing sintering process according to the technique disclosed in relation to the previous non-limiting implementations. The shallow surface oxide stripping can be done by a short rinse of the mesoporous silicon layer in a dilute HF solution, by exposing it to HF vapors, by selective RIE or by any other method known to those skilled in the art.

It should be noted that that the low-doped side of the bonded wafer can be provided with an antireflection structure prior to or after the electrochemical etching process as was disclosed in relation to the previous aspect of the present illustrative exemplary non-limiting implementation. It should be also noted that the mechanical and environmental stability of the mesoporous silicon filter can be further enhanced by the bonding of another wafer of material that is transparent at the desired wavelengths to the sealed mesoporous silicon surface of the filter as was disclosed in accordance with the previous illustrative exemplary non-limiting implementation.

Such exemplary, non-limiting illustrative implementations provide workable mesoporous silicon optical filters for applications that require the operation of such filters at low temperatures (below 100° K). Such filters will exhibit much better mechanical stability than, for example, common multilayer interference filters made of layers of dissimilar materials due to the matched thermal expansion between the layers of different porosity in a mesoporous silicon multilayer structure, and thus due to the absence of the mechanical stress between said layers.

It is possible to use the mesoporous silicon optical filter for low temperature operations. Such filter may consist of alternative high-porosity/low porosity layers of mesoporous silicon. Said layer can be obtained by electrochemical etching of silicon, as described above. Said mesoporous silicon filter structure can be sintered to enhance the environmental and/or mechanical stability of the filter structure and the wafer bonding technique can be employed as well, as was disclosed in relation to the previous illustrative exemplary non-limiting implementations. In this exemplary illustrative arrangement, said bonded wafer is preferably a silicon wafer with the same or different doping density, since the temperature expansions of both bonded wafers have to be matched over the fairly wide range of temperatures (from above room temperature down to liquid nitrogen or liquid helium temperatures, whatever is required by the particular application of the filters). The removal of the portion of the nonporous part of the silicon wafer as disclosed above may not be required, since the free carrier absorption edge of the silicon at low temperature is strongly -shifted towards longer wavelengths. The antireflection structure in this mode of manufacturing an optical filter is preferably done in a form of a structured silicon layer, as was disclosed in relation to the previous arrangements and aspects of exemplary illustrative non-limiting implementations, since in such a case the delamination effects will be prevented. The structure (i.e., the thicknesses and/or the porosities, and through that, the refractive indices) of the mesoporous layers may comprise the filtering medium. Said mesoporous silicon optical filter for applications requiring cold temperatures can be adjusted to take into account the shift of the Bragg resonance spectral position due to temperature differences. This can be accommodated by preliminary calibration runs.

Mesoporous silicon optical filters for cold temperature applications may comprise dielectric mirrors serving to reflect the light efficiently within some spectral range. Such a dielectric mirror could utilize a simple quarter-wave stack consisting of alternating, high refractive index (low porosity)/low refractive index (high porosity) layers, each having an optical thickness exactly equal, in one exemplary arrangement, to a quarter of some wavelength (typically the wavelength of the center of the reflection band). In such an exemplary design, the various low porosity layers may have the same physical thickness and the various high porosity layers may have the same physical thickness. Alternatively, to enlarge the reflection band, the filter structure can consist of the number of quarter wave stacks with different central wavelengths for each stack. The phase-matching spacer layers can be disposed between said stacks to suppress parasitic bands of low reflection. Alternatively, to enlarge the reflection band, the filter structure can be made such that the period of each successive high porosity/low porosity bilayer is slowly (adiabatically) changed. Any dielectric reflector design known to those skilled in the art can be easily implemented instead entirely in silicon through the control of the electrochemical parameters (or control of the original wafer structure).

Mesoporous silicon optical filters for cold temperature applications may include, for example, band-blocking filters which do not transmit light efficiently within some spectral band (i.e., to “block” it). Such a band-blocking filter could, for example, utilize a simple quarter-wave stack consisting of alternative high refractive index (low porosity)/low refractive index (high porosity) layers, each having an optical thickness exactly equal to a quarter of some wavelength (typically the center wavelength of the blocking band). In such an exemplary design, all low porosity layers may have the same physical thickness and all the high porosity layers may have the same physical thickness. Alternatively, to enlarge the blocking band, the filter structure can consist of a number of the quarter wave stacks with different central wavelengths for each stack. Phase-matching spacer layers can be disposed between the stacks to suppress parasitic bands of high transmission. Alternatively, to enlarge the blocking band, a filter structure can be made such that the period of each successive high porosity/low porosity bilayer is slowly (adiabatically) changed. The width of the blocking band can be also adjusted by adjusting the refractive index contrast between the adjacent layers by means of adjusting the porosity contrast. The smaller contrast will result in a narrower blocking band while the higher contrast will result in wider blocking band. Any other band blocking filter design well known to those skilled in the art can be easily implemented entirely in silicon by means of the control of the electrochemical parameters (or control of the original wafer structure) herein described.

Alternatively, mesoporous silicon optical filters for cold temperature applications may comprise a band pass filter serving to transmit the light efficiently within some spectral band (called the pass band) and to “block” the transmission within some wavelength ranges around said pass band. Such a band-pass filter could, for example, utilize two simple quarter-wave stacks each consisting of alternating high refractive index (low porosity)/low refractive index (high porosity) layers, each having an optical thickness, for example, exactly equal to a quarter of some wavelength (typically around the center wavelength of the pass band) with a single cavity separating said quarter-wave stacks. Usually the cavity layer has an optical thickness of a multiple of half the center wavelength of the pass band. In such a design, all the low porosity layers have the same physical thickness and all the high porosity layers have the same physical thickness. Alternatively, more than two stacks can be used, with more than one cavity layer used to get a more square shape of the pass band (so-called multiple cavity designs, well known to those skilled in the art). To enlarge the blocking bands around said pass band, the quarter wave reflector structure can consist of a number of quarter wave stacks with different central wavelengths for each stack. To enlarge the blocking bands around the pass band, the filter structure can be made such that the period of each successive high porosity/low porosity bilayer is slowly (adiabatically) changed in said quarter wave stacks. The width of the pass band can be also adjusted by adjusting the refractive index contrast between the adjacent layers by means of adjusting the porosity contrast. The smaller contrast will result in a narrower pass band while the higher contrast will result in a wider pass band. For the wide band-pass filters, instead of using the cavities to induce the band, two or more quarter wave stacks can be used with sufficiently spaced central wavelengths. Phase-matching layers can be disposed between said quarter wave stacks. Any other band pass filter design well known to those skilled in the art can be easily implemented instead entirely in silicon through the control of the electrochemical parameters (or control of the original wafer structure) herein described.

Mesoporous silicon optical filters for cold temperature applications may also comprise dichroic reflector type filters serving to reflect light efficiently within two separated spectral bands and to “block” the transmission within some wavelengths between and/or around said pass bands. Such an exemplary dichroic reflector arrangement could for example utilize two quarter-wave stacks each consisting of alternating high refractive index (low porosity)/low refractive index (high porosity) layers. In such a design, all the low porosity layers may have the same physical thickness and all the high porosity layers may have the same physical thickness for each of said quarter wave stacks. Any other dielectric reflector design well known to those skilled in the art can be easily implemented instead entirely in silicon through the control of the electrochemical parameters (or control of the original wafer structure) herein described.

Still, alternatively, said mesoporous silicon optical filters for cold temperature applications may comprise edge-type filters serving to transmit the light efficiently on one side of said edge and to reject the light on another side of said edge. Said edge filter can be either a long-pass filter or short-pass filter In the former case, light with wavelengths longer than the edge wavelength is transmitted and light with wavelengths shorter than the edge wavelength is blocked. In the latter case, the opposite is true. Such an edge filter could, for example, utilize a quarter-wave stack consisting of alternating high refractive index (low porosity)/low refractive index (high porosity) layers each having optical thickness exactly equal to a quarter of some wavelength, said wavelength being at some optical distance from the edge. In such a design, all the low porosity layers may have the same physical thickness and all the high porosity layers may have the same physical thickness for each of said quarter wave stacks. Any other edge filter design well known to those skilled in the art can be easily implemented instead entirely in silicon through control of the electrochemical parameters (or control of the original wafer structure) herein described.

Spectral filters as described above can be applied, for example, to almost any application requiring cooling of the filter. One of the illustrative examples of such applications is an astronomical far infrared imaging. In such application, the filters and detector may be cooled to liquid helium temperatures or lower in order to suppress thermal emissios from the optics that can interfere with the images to be recorded. Another exemplary, non-limiting application of such filters is a military application that uses mid or far infrared focal plane arrays (FPA) to visualize the battlefield in a sandy or dusty environment. In such applications, the filters and detectors are cooled to either liquid helium or liquid nitrogen temperature to suppress the thermal glow of the optics. Since the filters of the exemplary, non-limiting illustrative arrangement are thermally, mechanically and environmentally stable and can be operated out to the far infrared range, they are well suited for these and other applications.

While the technology herein has been described in connection with exemplary illustrative non-limiting implementations, the invention is not to be limited by this disclosure. The invention is intended to be defined by the claims and to cover all corresponding and equivalent arrangements whether or not specifically disclosed herein.

1. A method of making an optical filter comprising:
providing a substrate wafer of single-crystal silicon having a first surface and a second surface,
electrochemically etching the mesoporous silicon multilayer structure on the first surface of the filter, and
sintering of said mesoporous silicon multilayer filter structure.

2. A method of claim 1 wherein said electrochemical etching includes connecting the substrate as an electrode, contacting the first surface of the substrate with an electrolyte, applying an electrical current between said electrodes, and continuing etching to form said mesoporous multilayer structure extending to a desired depth

3. The method of claim 2, wherein said electrolyte is a fluoride-containing, acidic electrolyte, containing hydrofluoric acid in a range of 1% to 50% by volume

4. The method of claim 2, wherein at least one electrochemical etching parameter, selected from the group consisting of electrical current density, electrolyte temperature, electrolyte composition and/or applied voltage, is changed in a predetermined fashion with time during the electrochemical etching process

5. The method of claim 1 wherein said sintering of the mesoporous silicon multilayer comprises heat-treating of said mesoporous silicon multilayer in a hydrogen-containing, reducing atmosphere.

6. The method of claim 5 wherein said hydrogen-containing reducing atmosphere contains 100% hydrogen or hydrogen plus an inert gas.

7. The method of claim 5 wherein a layer of silicon dioxide is formed on the pore walls of the mesoporous silicon structure prior to said heat treatment in a hydrogen-containing, reducing atmosphere.

8. The method of claim 7 wherein the layer of said silicon dioxide is removed from the pore walls at the first surface of said mesoporous silicon structure prior to said heat treatment in a hydrogen-containing, reducing atmosphere.

9. The method of claim 1, further including the removal of the nonporous remainder of the wafer.

10. The method of claim 9, wherein said removal of the unwanted remainder of the wafer comprises a step selected from the group consisting of reactive ion etching, chemical etching, grinding, mechanical and/or chemical-mechanical polishing.

11. The method of claim 1, further providing an antireflective structure on the first, second or both surfaces of said optical filter that is designed to suppress reflections from said surfaces of said spectral filter in at least some wavelength ranges within the transparency wavelength range of said spectral filter.

12. The method of claim 11 wherein said antireflective structure comprises at least one layer of transparent material disposed by a technique chosen from the group consisting of thermal oxidation, chemical vapor deposition, physical vapor deposition and/or thermal evaporation.

13. The method of claim 11 wherein said antireflective structure comprises a structured silicon layer, wherein said structuring is performed by chemical etching or reactive ion etching of silicon through a mask made of metal, photoresist, polymer, or a combination thereof.

14. The method of claim 1 further including sealing said spectral filter with two flat plates of material that are transparent within the transparency range of said spectral filter.

15. The method of claim 14 wherein said sealing step comprises at least one method selected from the group consisting of anodic bonding, fusion bonding, adhesive bonding or glass frit bonding.

16. A method of making an optical filter comprising:
providing two substrate wafers of single-crystal silicon with substantially different doping densities but the same doping types, bonding said two wafers such that the bonding interface is electrically conductive, thus forming a bonded wafer comprising a first surface with higher doping density and a second surface with lower doping density, and
electrochemically etching the mesoporous silicon multilayer structure on the first surface of the bonded wafer.

17. A method of claim 16 wherein said substrate wafers are (100)-oriented p-doped silicon wafers.

18. A method of claim 16 wherein the higher-doped substrate wafer has a resistivity in the range of 0.001 and 0.2 Ωcm.

19. A method of claim 16 wherein the lower doped substrate wafer has a resistivity in the range of 1 and 200 Ωcm.

20. A method of claim 16 wherein said wafer bonding is accomplished by fusion bonding.

21. A method of claim 16 wherein the higher-doped side of the bonded wafer is thinned after bonding and prior to electrochemical etching.

22. A method of claim 16 wherein said electrochemical etching includes connecting the silicon substrate as an electrode, contacting the first surface of the substrate with an electrolyte, applying an electrical current between said electrodes, and continuing etching to form said mesoporous multilayer structure extending to a desired depth

23. The method of claim 22, wherein said electrolyte is a fluoride-containing, acidic electrolyte, containing hydrofluoric acid in the range of 1% to 50% by volume

24. The method of claim 22, wherein at least one electrochemical etching parameter selected from the group consisting of electrical current density, electrolyte temperature, electrolyte composition and/or applied voltage is changed in a predetermined fashion with time during the electrochemical etching process.

25. The method of claim 16, further including sintering of said mesoporous silicon multilayer, said sintering of the mesoporous silicon multilayer comprising heat-treating of said mesoporous silicon multilayer in a hydrogen-containing, reducing atmosphere.

26. The method of claim 25 wherein said hydrogen-containing, reducing atmosphere contains 100% hydrogen or hydrogen plus an inert gas.

27. The method of claim 25 wherein a layer of silicon dioxide is formed on the pore walls of the mesoporous silicon structure prior to said heat treatment in a hydrogen-containing, reducing atmosphere.

28. The method of claim 27 wherein the layer of said silicon dioxide is removed from the pore walls near the first surface of said mesoporous silicon structure prior to said heat treatment in a hydrogen-containing reducing atmosphere.

29. The method of claim 16, further including sealing of the surface of the mesoporous silicon multilayer with a layer of material at least partially transparent within the transparency range of the optical filter.

30. The method of claim 29 wherein said layer of transparent material is deposited by a technique selected from the group consisting of physical vapor deposition and chemical vapor deposition.

31. The method of claim 16 further including partial oxidation of the mesoporous silicon multilayer.

32. The method of claim 16, further providing an antireflective structure on the first, second or both surfaces of said optical filter intended to suppress the reflection from said surfaces of said spectral filter in at least one wavelength range within the transparency wavelength range of said spectral filter.

33. The method of claim 32 wherein said antireflective structure comprises at least one layer of transparent material disposed by a technique chosen from the group consisting of thermal oxidation, chemical vapor deposition and/or physical vapor deposition.

34. The method of claim 32 wherein said antireflective structure comprises a structured silicon layer, wherein said structuring is performed by chemical etching or reactive ion etching of silicon through a metal, photoresist or polymer mask, or a combination thereof.

35. The method of claim 16 further including sealing said spectral filter with two flat plates of material that are transparent within the transparency range of said spectral filter.

36. The method of claim 35 wherein said sealing step comprises at least one of the group consisting of anodic bonding, fusion bonding, adhesive bonding and glass frit bonding.

37. An optical filter for cryogenic temperature applications comprising:
a substrate wafer of single-crystal semiconductor having a first surface and a second surface; and
a mesoporous silicon multilayer disposed on said wafer.
